(19) United States
(12) Patent Application Publication
(10) Pub. No.: US 2023/0328735 A1
(43) Pub. Date: Oct. 12, 2023

(54) PROCESSING TIMELINE INDICATION FOR SCHEDULING A FEEDBACK RESOURCE

(71) Applicant: QUALCOMM Incorporated, San Diego, CA (US)

(72) Inventors: Tianyang BAI, Somerville, NJ (US); Hua WANG, Basking Ridge, NJ (US); Junyi LI, Fairless Hills, PA (US)

(21) Appl. No.: 17/658,196

(22) Filed: Apr. 6, 2022

(51) Int. Cl. H04W 72/12; H04L 5/00

(52) U.S. Cl. CPC H04W 72/1284; H04L 5/0055

(57) ABSTRACT

Various aspects of the present disclosure generally relate to wireless communication. In some aspects, a user equipment (UE) may transmit, to a network entity, a processing timeline indication associated with a physical downlink shared channel (PDSCH) communication, wherein the processing timeline indication indicates a minimum feedback channel offset value for processing the PDSCH communication. The UE may receive, from the network entity, a physical uplink control channel (PUCCH) indication that schedules a PUCCH resource for transmitting a feedback communication associated with the PDSCH communication, wherein the PUCCH indication is based at least in part on the processing timeline indication. Numerous other aspects are described.

### FIELD OF THE DISCLOSURE

Aspects of the present disclosure generally relate to wireless communication and to techniques and apparatuses for a processing timeline indication for scheduling a feedback resource.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, to a network entity, a processing timeline indication associated with a physical downlink shared channel (PDSCH) communication, wherein the processing timeline indication indicates a minimum feedback channel offset value for processing the PDSCH communication. The method may include receiving, from the network entity, a physical uplink control channel (PUCCH) indication that schedules a PUCCH resource for transmitting a feedback communication associated with the PDSCH communication, wherein the PUCCH indication is based at least in part on the processing timeline indication.

Some aspects described herein relate to a method of wireless communication performed by a network entity. The method may include receiving, from a UE, a processing timeline indication associated with a PDSCH communication, wherein the processing timeline indication indicates a minimum feedback channel offset value for processing the PDSCH communication. The method may include transmitting, to the UE, a PUCCH indication that schedules a PUCCH resource for transmitting a feedback communication associated with the PDSCH communication, wherein the PUCCH indication is based at least in part on the processing timeline indication.

Some aspects described herein relate to an apparatus for wireless communication at a UE. The apparatus may include a memory and one or more processors coupled to the memory. The one or more processors may be configured to transmit, to a network entity, a processing timeline indication associated with a PDSCH communication, wherein the processing timeline indication indicates a minimum feedback channel offset value for processing the PDSCH communication. The one or more processors may be configured to receive, from the network entity, a PUCCH indication that schedules a PUCCH resource for transmitting a feedback communication associated with the PDSCH communication, wherein the PUCCH indication is based at least in part on the processing timeline indication.

Some aspects described herein relate to an apparatus for wireless communication at a network entity. The apparatus may include a memory and one or more processors coupled to the memory. The one or more processors may be configured to receive, from a UE, a processing timeline indication associated with a PDSCH communication, wherein the processing timeline indication indicates a minimum feedback channel offset value for processing the PDSCH communication. The one or more processors may be configured to transmit, to the UE, a PUCCH indication that schedules a PUCCH resource for transmitting a feedback communication associated with the PDSCH communication, wherein the PUCCH indication is based at least in part on the processing timeline indication.

Some aspects described herein relate to a non-transitory computer-readable medium that stores a set of instructions for wireless communication by a UE. The set of instructions, when executed by one or more processors of the UE, may cause the UE to transmit, to a network entity, a processing timeline indication associated with a PDSCH communication, wherein the processing timeline indication indicates a minimum feedback channel offset value for processing the PDSCH communication. The set of instructions, when executed by one or more processors of the UE, may cause the UE to receive, from the network entity, a PUCCH indication that schedules a PUCCH resource for transmitting a feedback communication associated with the PDSCH communication, wherein the PUCCH indication is based at least in part on the processing timeline indication.

Some aspects described herein relate to a non-transitory computer-readable medium that stores a set of instructions for wireless communication by a network entity. The set of instructions, when executed by one or more processors of the network entity, may cause the network entity to receive, from a UE, a processing timeline indication associated with a PDSCH communication, wherein the processing timeline indication indicates a minimum feedback channel offset value for processing the PDSCH communication. The set of instructions, when executed by one or more processors of the network entity, may cause the network entity to transmit, to the UE, a PUCCH indication that schedules a PUCCH resource for transmitting a feedback communication associated with the PDSCH communication, wherein the PUCCH indication is based at least in part on the processing timeline indication.

Some aspects described herein relate to an apparatus for wireless communication. The apparatus may include means for transmitting, to a network entity, a processing timeline indication associated with a PDSCH communication, wherein the processing timeline indication indicates a minimum feedback channel offset value for processing the PDSCH communication. The apparatus may include means for receiving, from the network entity, a PUCCH indication that schedules a PUCCH resource for transmitting a feedback communication associated with the PDSCH communication, wherein the PUCCH indication is based at least in part on the processing timeline indication.

Some aspects described herein relate to an apparatus for wireless communication. The apparatus may include means for receiving, from a UE, a processing timeline indication associated with a PDSCH communication, wherein the processing timeline indication indicates a minimum feedback channel offset value for processing the PDSCH communication. The apparatus may include means for transmitting, to the UE, a PUCCH indication that schedules a PUCCH resource for transmitting a feedback communication associated with the PDSCH communication, wherein the PUCCH indication is based at least in part on the processing timeline indication.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of a frame structure in a wireless communication network, in accordance with the present disclosure.

FIG. 5 is a diagram illustrating an example time domain resource assignment, in accordance with the present disclosure.

FIG. 6 is a diagram illustrating an example associated with a processing timeline indication for scheduling a feedback resource, in accordance with the present disclosure.

FIG. 7 is a diagram illustrating an example associated with a beam reporting process, in accordance with the present disclosure.

FIG. 8 is a diagram illustrating an example process performed, for example, by a UE, in accordance with the present disclosure.

FIG. 9 is a diagram illustrating an example process performed, for example, by a network entity, in accordance with the present disclosure.

FIG. 10 is a diagram of an example apparatus for wireless communication, in accordance with the disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

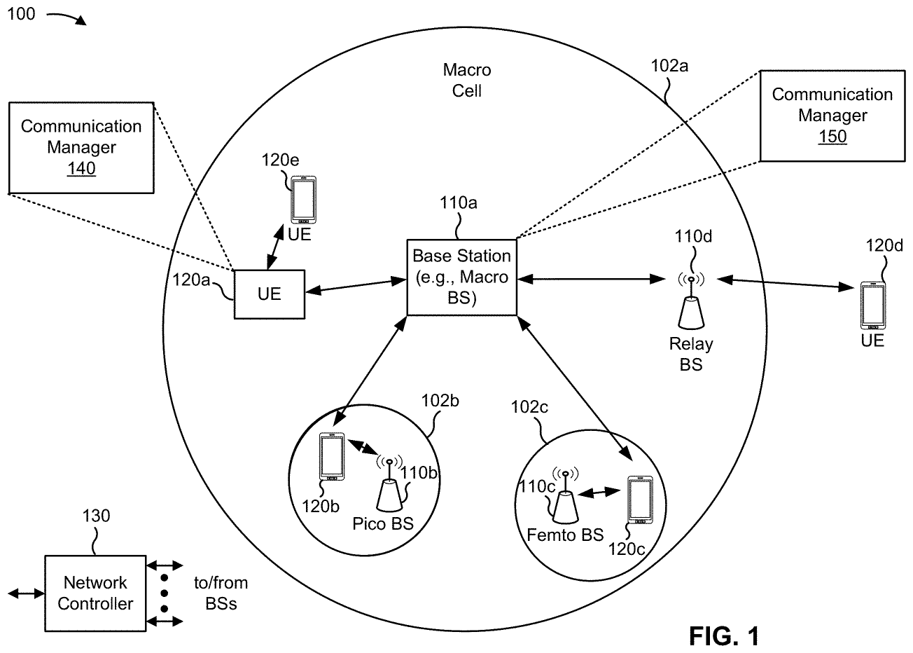

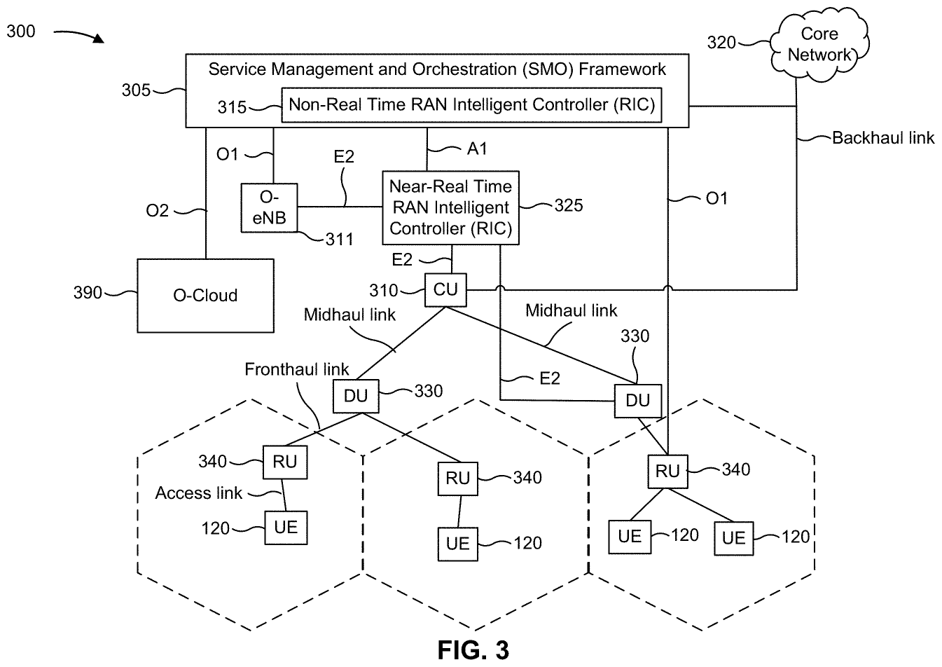

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although the base station 110 is shown as an integral unit in FIG. 1, aspects of the disclosure are not so limited. In some other aspects, the functionality of the base station 110 may be disaggregated according to an open radio access network (RAN) (O-RAN) architecture or the like, which is described in more detail in connection with FIG. 3. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network entity, a processing timeline indication associated with a physical downlink shared channel (PDSCH) communication, wherein the processing timeline indication indicates a minimum feedback channel offset value for processing the PDSCH communication; and receive, from the network entity, a physical uplink control channel (PUCCH) indication that schedules a PUCCH resource for transmitting a feedback communication associated with the PDSCH communication, wherein the PUCCH indication is based at least in part on the processing timeline indication. Additionally, or alternatively, the communication manager 140 may perform one or more other operations described herein.

In some aspects, the network entity described elsewhere herein may include a communication manager. For example, when the network entity corresponds to the base station 110, the network entity may include a communication manager 150. As described in more detail elsewhere herein, the communication manager 150 may receive, from a UE, a processing timeline indication associated with a PDSCH communication, wherein the processing timeline indication indicates a minimum feedback channel offset value for processing the PDSCH communication; and transmit, to the UE, a PUCCH indication that schedules a PUCCH resource for transmitting a feedback communication associated with the PDSCH communication, wherein the PUCCH indication is based at least in part on the processing timeline indication. Additionally, or alternatively, the communication manager 150 may perform one or more other operations described herein.

As indicated above, FIG. 1 is provided as an example. Other examples may differ from what is described with regard to FIG. 1.

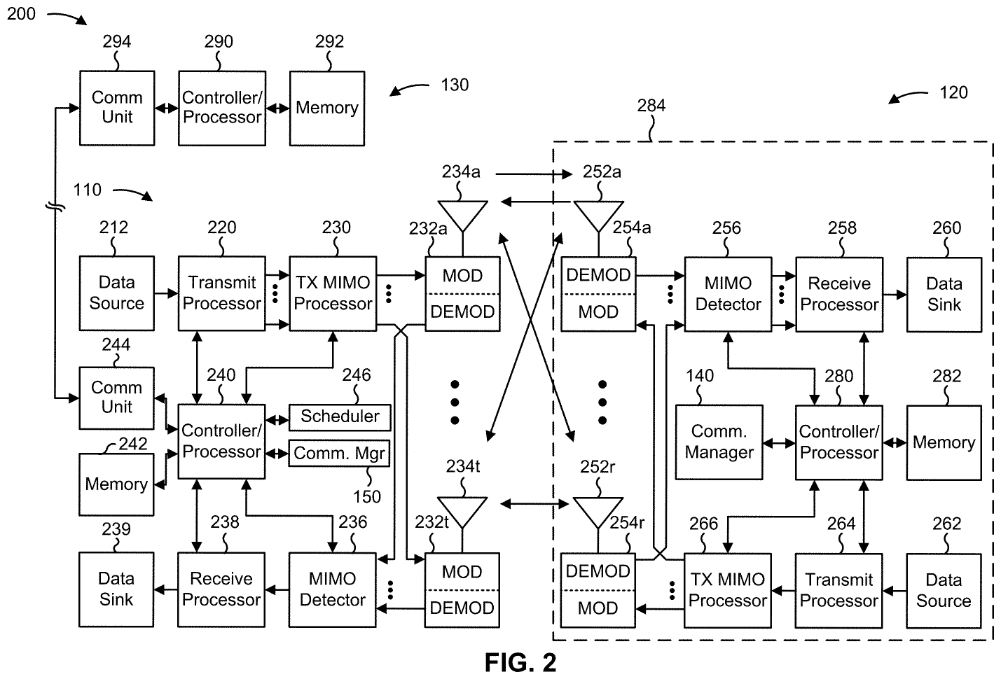

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T>1). The UE 120 may be equipped with a set of antennas 252a through 252r, such as R antennas (R>1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

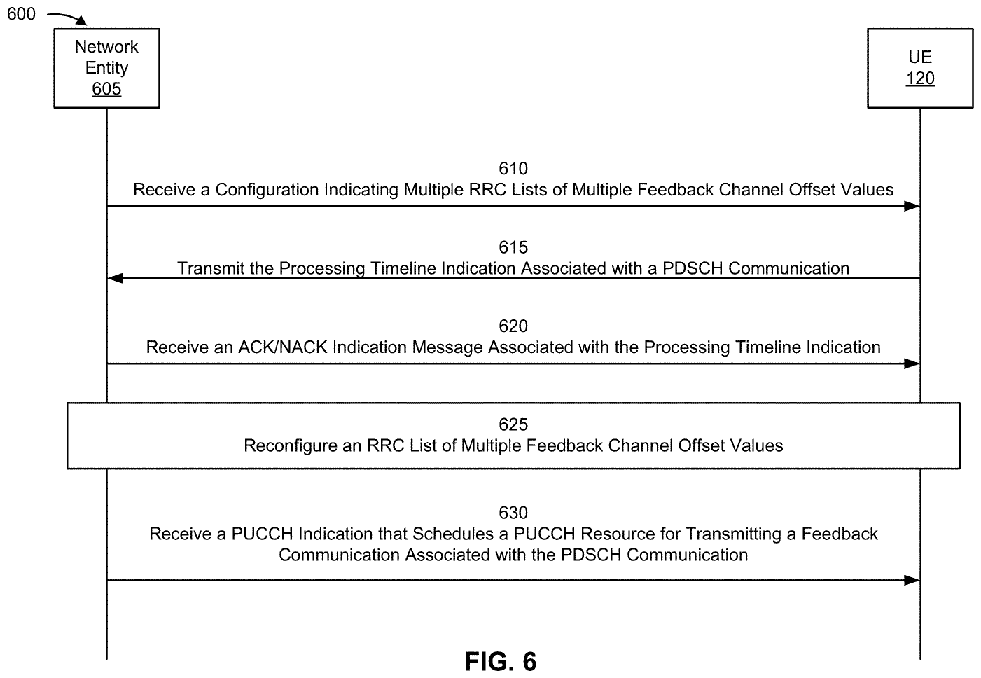

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-11).

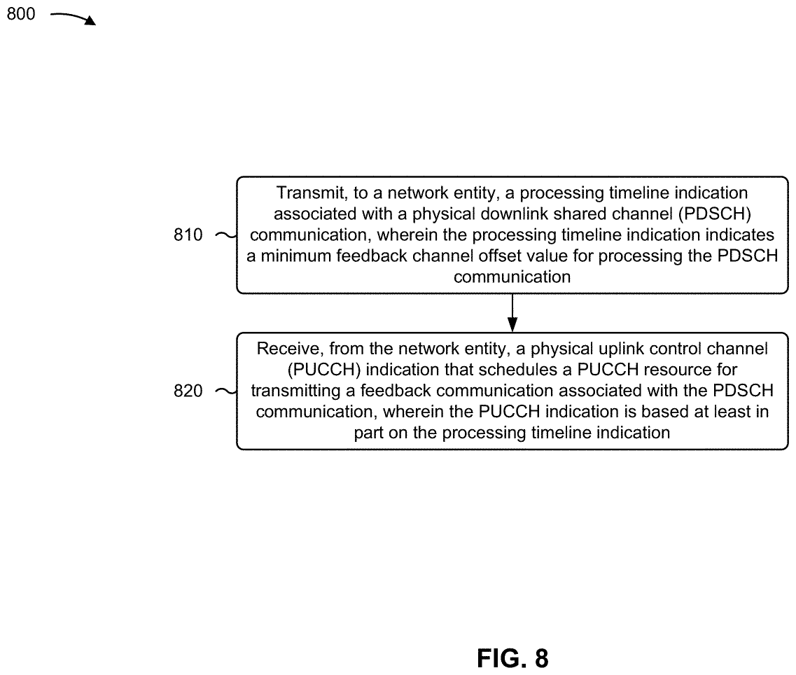

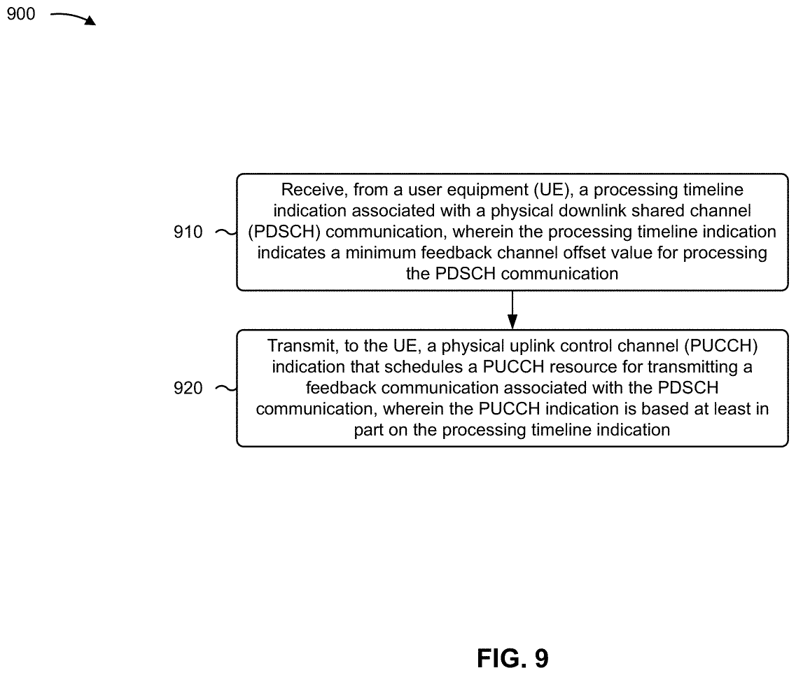

The controller/processor 240 of the base station 110, the controller/processor 280 of the UE 120, and/or any other component(s) of FIG. 2 may perform one or more techniques associated with a processing timeline indication for scheduling a feedback resource, as described in more detail elsewhere herein. In some aspects, the network entity described herein is the base station 110, is included in the base station 110, or includes one or more components of the base station 110 shown in FIG. 2. The controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for transmitting, to a network entity, a processing timeline indication associated with a PDSCH communication, wherein the processing timeline indication indicates a minimum feedback channel offset value for processing the PDSCH communication; and/or means for receiving, from the network entity, a PUCCH indication that schedules a PUCCH resource for transmitting a feedback communication associated with the PDSCH communication, wherein the PUCCH indication is based at least in part on the processing timeline indication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for receiving, from a UE, a processing timeline indication associated with a PDSCH communication, wherein the processing timeline indication indicates a minimum feedback channel offset value for processing the PDSCH communication; and/or means for transmitting, to the UE, a PUCCH indication that schedules a PUCCH resource for transmitting a feedback communication associated with the PDSCH communication, wherein the PUCCH indication is based at least in part on the processing timeline indication. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of a disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU). “Network entity” or “network node” can refer to a disaggregated base station, or to one or more units of a disaggregated base station (such as one or more CUs, one or more DUs, one or more RUs, or a combination thereof). “Network entity” or “network node” can refer to a disaggregated base station, or to one or more units of a disaggregated base station (such as one or more CUs, one or more DUs, one or more RUs, or a combination thereof).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (MC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit—User Plane (CU-UP)), control plane functionality (e.g., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

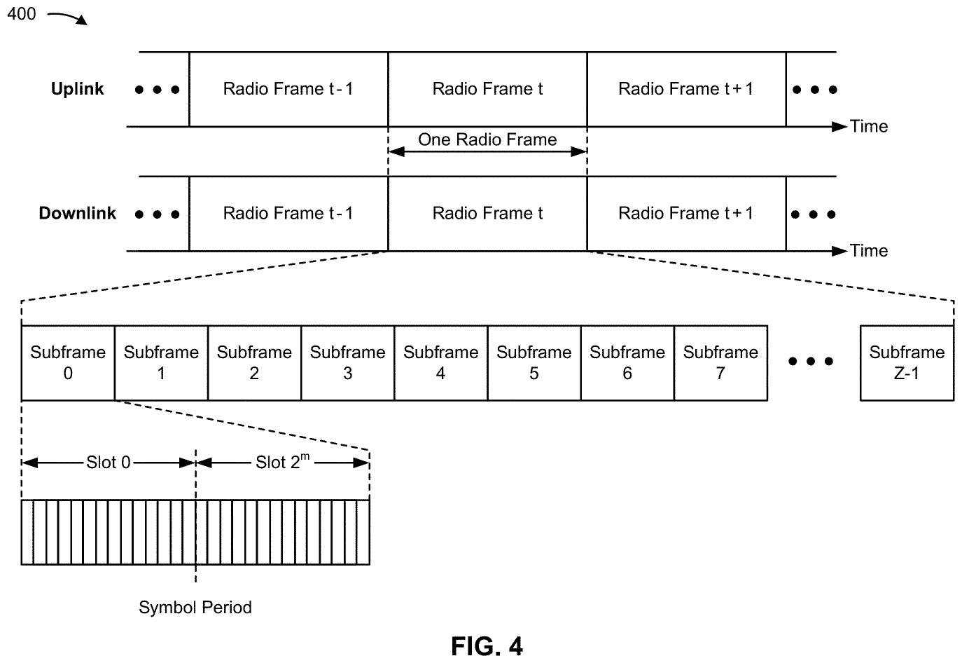

FIG. 4 is a diagram illustrating an example 400 of a frame structure in a wireless communication network, in accordance with the present disclosure.

The frame structure shown in FIG. 4 is for frequency division duplexing (FDD) in a telecommunication system, such as LTE or NR. The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z>1) subframes (e.g., with indices of 0 through Z−1). Each subframe may have a predetermined duration (e.g., 1 ms) and may include a set of slots (e.g., 2p slots per subframe are shown in FIG. 4, where p is an index of a numerology used for a transmission, such as 0, 1, 2, 3, 4, or another number). Each slot may include a set of L symbols. For example, each slot may include fourteen symbols (e.g., as shown in FIG. 4), seven symbols, or another number of symbols. In a case where the subframe includes two slots (e.g., when p=1), the subframe may include 2L symbols, where the 2L symbols in each subframe may be assigned indices of 0 through 2L−1. In some aspects, a scheduling unit for the FDD may be frame-based, subframe-based, slot-based, mini-slot based, or symbol-based.

As indicated above, FIG. 4 is provided as an example. Other examples may differ from what is described with respect to FIG. 4.

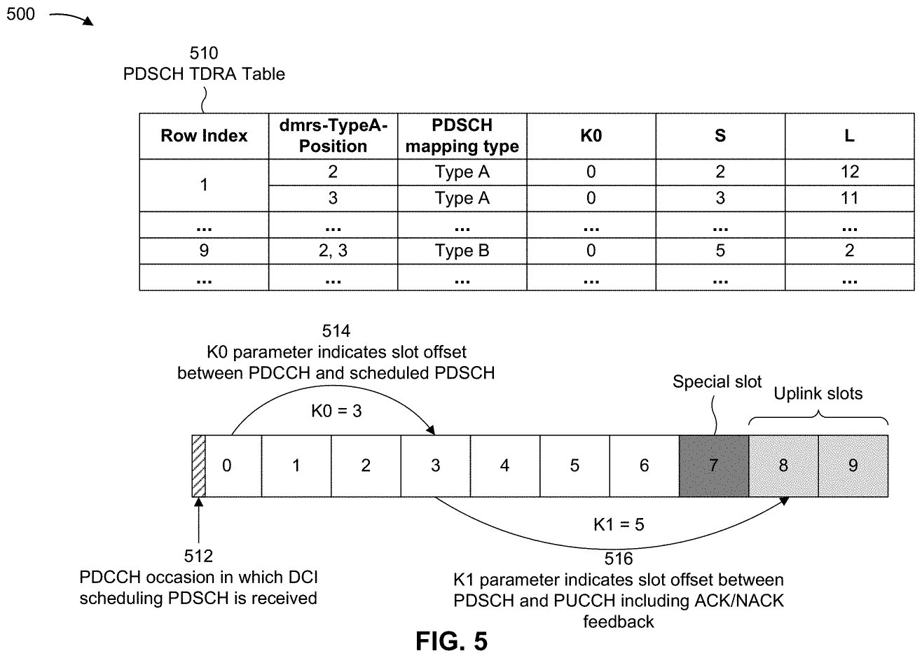

FIG. 5 is a diagram illustrating an example time domain resource assignment (TDRA) 500, in accordance with the present disclosure.

FIG. 5 shows an example downlink TDRA table 510, which may be a PDSCH TDRA table. In some aspects, the base station 110 and the UE 120 may use a different TDRA table than that shown in FIG. 5, such as for different configurations, different cells, and/or different sub-carrier spacings of cells.

When scheduling a downlink communication, a base station 110 may transmit a physical downlink control channel (PDCCH) carrying downlink control information (DCI) that indicates a TDRA for the downlink communication. For example, the DCI may include a TDRA field that includes a TDRA index value. The TDRA index value may indicate a row index of a corresponding TDRA table, and the row index may correspond to a set of TDRA parameters (sometimes referred to as scheduling parameters or scheduling information). The base station 110 and the UE 120 may use the TDRA parameters in the corresponding row index for the downlink communication scheduled via the DCI. In the example shown in FIG. 5, a TDRA index value of m in the DCI may correspond to a row index of m+1 in the TDRA table. For example, a TDRA index value of 0 may correspond to a row index of 1.

Moreover, the TDRA parameters may include, for example, a K0 value, an S value, and an L value. The K0 value may represent a timing offset (e.g., in number of slots) between a slot containing the scheduling DCI (carrying a grant that schedules the PDSCH communication) and a slot containing the scheduled PDSCH communication (scheduled via the scheduling DCI). For example, as shown in FIG. 5, and by reference number 512, a UE may receive DCI scheduling a PDSCH in a PDCCH monitoring occasion of slot number 0, and a value of the K0 parameter may indicate the slot in which the UE can expect to receive the PDSCH scheduled via the DCI. For example, as shown by reference number 514, the UE may expect to receive the PDSCH in slot number 3 based on receiving the scheduling DCI in slot number 0 with the K0 parameter indicating a timing offset of three slots. The S value may represent a starting symbol for the PDSCH communication in the indicated slot. The L value may represent a length (e.g., a number of consecutive symbols) of the PDSCH communication (e.g., in the indicated slot). In some cases, the S value and the L value may collectively be referred to as a start and length indicator value (SLIV). In some aspects, the same row index value may correspond to a different set of TDRA parameters depending on a Type A DMRS position (e.g., a symbol within a resource block that contains the DMRS) and/or a PDSCH mapping type (e.g., indicating a starting symbol of the DMRS, a length of the DMRS, and/or whether slot-based scheduling or mini-slot-based scheduling is used).

Furthermore, in some aspects, a K1 parameter may be used to indicate a timing offset between the PDSCH scheduled via the DCI and a slot in which the UE is to transmit a PUCCH that carries acknowledgement/negative acknowledgement (ACK/NACK) feedback for the PDSCH. For example, as shown by reference number 516, the UE may be expected to receive a PDSCH in slot number 3 based on the value of the K0 parameter, and may transmit a PUCCH that carries ACK/NACK feedback for the PDSCH in slot number 8 based on the K1 parameter indicating a timing offset of five slots from the slot in which the PDSCH is scheduled (e.g., slot number 3 in the illustrated example). In cases where a PDCCH contains a multi-PDSCH grant, the K1 parameter may be counted from the slot in which the last granted PDSCH is scheduled.

The K1 parameter may be determined based on a TDRA field in the scheduling DCI (sometimes referred to as PDSCH-to-HARQ feedback timing indicator), which is used to indicate one slot offset value from a pre-configured list of slot offset values. When a DCI format 1_0 is used to schedule a PDSCH, the pre-configured list may have a value from one to eight (e.g., one slots to eight slots); that is, the pre-configured list may be {1,2,3,4,5,6,7,8}. Alternatively, when a DCI format 1_1 is used to schedule a PDSCH, the pre-configured list may be an RRC configured list (sometimes referred to as PUCCH-Configuration.dl-DataToUL-Ack). The TDRA field in the scheduling DCI (e.g., PDSCH-to-HARQ feedback timing indicator) indicates which offset value from the preconfigured list should be used to provide ACK/NACK feedback. For example, when the pre-configured list (e.g., an RRC list) contains values {3,4,5,6,7,8,9,10}, a PUCCH in slot n can potentially be used to provide ACK/NACK feedback for a PDSCH in slot {n−3, n−4, n−5, n−6, n−7, n−8, n−9, n−10}, according to which value of the list (e.g., which one of {3,4,5,6,7,8,9,10}) is indicated to the TDRA field in the scheduling DCI (e.g., PDSCH-to-HARQ feedback timing indicator). More particularly, if the TDRA field in the scheduling DCI (e.g., PDSCH-to-HARQ feedback timing indicator) indicates that the third offset value (e.g., K1 value) in the RRC list (five slots in this example) should be used, a PUCCH in slot n can potentially be used to provide ACK/NACK feedback for a PDSCH in slot n−5. In the example shown in FIG. 5, slot 8 may be used to provide ACK/NACK feedback for a PDSCH in slot 3. The UE 120 may provide ACK/NACK feedback in the PUCCH in the indicated slot using either one bit for a transport block (TB), or, when code block group (CBG) feedback is used, multiple bits for a TB.

Processing, or decoding, time for a given PDSCH may vary at the UE 120 based at least in part on the type of decoding implementation used, or the like. For example, with regards to the demodulation step of a decoding process, the UE 120 may selectively implement a number of different types of demodulation schemes depending on the specific application. In some aspects, the UE 120 may use linear minimum mean-square error (MMSE) demodulation, which may take a minimum amount of time to perform with relatively few computations, but which may result in a relatively high decoding failure rate. In some other aspects, the UE 120 may use a more complicated nonlinear demodulation scheme, such as a maximum likelihood type with different sizes of candidate modulations, which requires more time and many computations to perform, but which may result in a relatively low decoding failure rate (e.g., the nonlinear demodulation scheme may decode some of the cases that the MMSE demodulation may miss). Moreover, the UE 120 may optionally perform additional processes after the demodulation step (such as compensating for nonlinear impairments due to power amplification or the like, performing a low density parity check (LDPC) decoding step after the demodulation step, or similar processes), which may add additional decoding time.

Moreover, the decoding process implemented by the UE 120 may be dynamically decided for each PDSCH occasion based on certain factors such as channel statistics (e.g., delay, Doppler profile, or the like), battery status, an MCS being employed, or similar factors. For example, in cases where the nonlinear demodulation scheme may provide little gain over MMSE demodulation, the UE 120 may implement MMSE demodulation, while in cases where the nonlinear demodulation scheme may lead to a much higher successful decoding rate than MMSE demodulation, the UE 120 may implement nonlinear demodulation. Moreover, in some aspects, a machine learning classification algorithm may be trained and implemented at the UE 120 to make the optimal decision as to whether to implement MMSE demodulation or nonlinear demodulation, and/or whether to implement certain post-demodulation processing such as compensating for nonlinear impairments dues to power amplification, performing an LDPC decoding step, or performing a similar process.

Because different decoding processes require different processing timelines, varying feedback offset values (e.g., K1 values) may be needed to accommodate each process. For example, a decoding process that implements MMSE demodulation, which, as described, is a relatively quick decoding process, may need a relatively short time to decode a TB and thus a relatively small K1 value may provide sufficient time to complete the process, while a decoding process that implements nonlinear demodulation, which, as described, is relatively slow, may need a relatively long time to decode a TB and thus a relatively large K1 value may be necessary to provide sufficient time to complete the process.

However, a base station 110 or other network entity scheduling a PDSCH and a corresponding ACK/NACK time in the PDSCH scheduling DCI may not know which decoding process the UE 120 is implementing. Moreover, the UE 120's choice of decoding process may be based at least in part on factors such as an estimated downlink channel, battery status, or other factors unknown to the base station 110 or other network entity, and thus the base station 110 or other network entity may not be able to determine what process the UE 120 is implementing. Accordingly, when scheduling a resource for the ACK/NACK communication (e.g., when selecting a K1 value), the base station 110 or other network entity may do so without knowledge of the decoding process being implemented by the UE 120. In some cases, this may result in the base station 110 or other network entity scheduling an ACK/NACK resource based on the longest decoding time at the UE 120 in order to ensure the UE 120 will have sufficient time to decode the PDSCH communication, which introduces unnecessary delay when the UE 120 is not implementing a relatively slow decoding processes (e.g., nonlinear demodulation or the like). Alternatively, the base station 110 or other network entity may schedule an ACK/NACK resource based on a relatively short decoding time at the UE 120, which may prevent the UE 120 from using advanced decoding processes, leading to increased decoding failure and retransmissions, and thus resulting in increased delay, overhead, and power consumption.

Some techniques and apparatuses described herein enable signaling, from a UE (e.g., the UE 120) to a network entity (e.g., a base station 110, a CU 310, a DU 330, an RU 340, or a similar network entity), of a processing timeline indication associated with a PDSCH communication. In some aspects, the processing timeline indication may indicate a minimum feedback channel offset value (e.g., a minimum K1 value) for processing the PDSCH communication based at least in part on a decoding process being implemented at the UE. The network entity may thus schedule a PUCCH resource for transmitting a feedback communication (e.g., an ACK/NACK communication) associated with the PDSCH communication based at least in part on the processing timeline indication. For example, the network entity may select a feedback channel offset value (e.g., K1 value) that is equal to or greater than the minimum feedback channel offset value indicated by the processing timeline indication. As a result, the feedback timeline may be tailored to a decoding process being implemented at the UE 120, avoiding unnecessary delay, reducing decoding failure and retransmissions, reducing overhead and power consumption, and resulting in overall more efficient network usage.

As indicated above, FIG. 5 is provided as an example. Other examples may differ from what is described with regard to FIG. 5.

FIG. 6 is a diagram illustrating an example 600 associated with a processing timeline indication for scheduling a feedback resource, in accordance with the present disclosure. As shown in FIG. 6, a network entity 605 (e.g., a base station 110, a CU 310, a DU 330, and RU 340, or a similar network entity) and a UE 120 may communicate with one another.

As shown by reference number 610, in some aspects, the UE 120 may receive, from the network entity 605, a configuration indicating multiple RRC lists of multiple feedback channel offset values (e.g., multiple K1 values). Each RRC list may be associated with a corresponding minimum feedback channel offset value. For example, in aspects in which the UE 120 is capable of multiple decoding processes, each requiring a different processing time (as described in connection with FIG. 5), the network entity 605 may configure the UE 120 with the multiple RRC lists of multiple feedback channel offset values, each one corresponding to a different minimum feedback channel offset value (and thus a different decoding process). Put another way, the potential K1 values in each list may be equal to or greater than a corresponding minimum feedback channel offset value. In some aspects, the multiple RRC lists may be added to the PUCCH-Configuration.dl-DataToUL-Ack parameter described above in connection with FIG. 5.

As shown by reference number 615, in some aspects, the UE 120 may transmit, to the network entity 605, a processing timeline indication associated with a PDSCH communication. The processing timeline indication may indicate a minimum feedback channel offset value (e.g., a minimum K1 value) for processing the PDSCH communication. Put another way, the UE 120 may determine one of multiple decoding processes to be used for a PDSCH communication, and signal to the network entity 605 a minimum feedback channel offset value needed to complete the decoding process. As described, for relatively simple decoding processes, such as ones implementing MMSE demodulation with little or no post-demodulation processing, the indicated minimum feedback channel offset value may be relatively small, while for relatively complex decoding processes, such as ones implementing nonlinear demodulation and/or post-demodulation processing, the indicated minimum feedback channel offset value may be relatively large.

In some aspects, the processing timeline indication may be transmitted using a MAC control element (MAC-CE) message. In such aspects, the UE 120 may transmit the processing timeline indication in an uplink resource scheduled by the network entity 605 specifically for providing the processing timeline indication. More particularly, in some aspects, the UE 120 may transmit, to the network entity 605, a scheduling request (SR) associated with the processing timeline indication, and, in response to the SR, the UE 120 may receive, from the network entity 605, a MAC-CE resource indication that schedules a resource for transmitting the MAC-CE message. Alternatively, the UE 120 may use a configured grant (CG) uplink resource or the like for transmitting the MAC-CE message. That is, the UE 120 may transmit the processing timeline indication to the network entity using a CG resource, which, in some aspects, may be a CG physical uplink shared channel (PUSCH) resource.

Additionally, or alternatively, in some aspects, the processing timeline indication may be applicable to a specific transmission configuration indicator (TCI) state. Put another way, the processing timeline indication may be beam-specific, with the chosen decoding process (and thus the minimum feedback channel offset value) being applicable to transmissions on a certain beam (e.g., transmissions associated with a certain TCI state). In some aspects, the network entity 605 may associate the minimum feedback channel offset value with a TCI state indicated for a UE 120 dedicated PDSCH transmission. That is, the network entity 605 may apply the minimum feedback channel offset value to the current indicated TCI for the PDSCH transmission. In some other aspects, the processing timeline indication may include additional information indicating the associated TCI state. More particularly, in some aspects, the minimum feedback channel offset value is associated with a TCI state indicated by the processing timeline indication.

In some aspects, the processing timeline indication shown by reference number 615 may be transmitted by the UE 120 using a layer 1 (L1) beam report occasion associated with a beam reporting process. A beam reporting process may be used by a UE (e.g., the UE 120) to report certain capabilities to a network entity (e.g., the network entity 605), such as panel-related capability and/or maximum sounding reference signal (SRS) port numbers per TCI, or the like. In some aspects, the UE 120 may use an L1 beam report occasion associated with the beam reporting process for transmitting the processing timeline indication.

Moreover, in some aspects, the UE 120 may indicate additional information using the beam reporting process, such as a candidate processing timeline indication that indicates multiple minimum feedback channel offset values (e.g., multiple K1 values) for processing PDSCH communications. In some aspects, each of the multiple minimum feedback channel offset values may be associated with a corresponding decoding process that may be performed by the UE 120. For example, the UE 120 may indicate a first minimum feedback channel offset value associated with a first, relatively quick decoding process, such as a decoding process that implements MMSE demodulation, and a second minimum feedback channel offset value, greater than the first minimum feedback channel offset value, associated with a second, more complex decoding process, such as a decoding process that implements nonlinear demodulation and/or post-demodulation processing steps. In such aspects, the processing timeline indication may indicate a selected minimum feedback channel offset value of the multiple minimum feedback channel offset values reported in the candidate processing timeline indication.

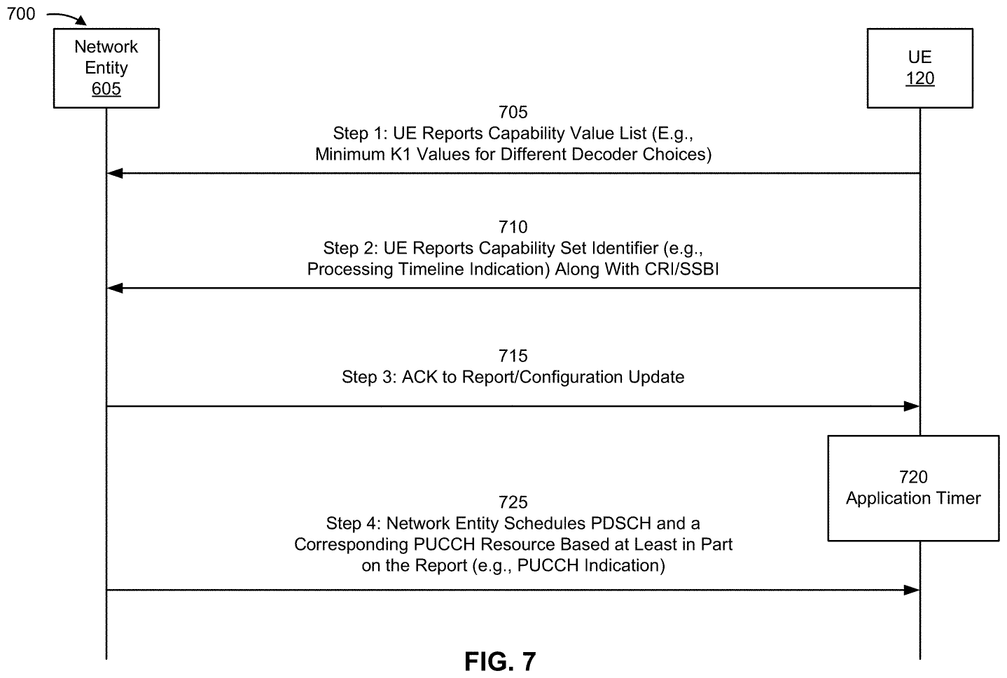

Moreover, in some aspects, the L1 beam report occasion may include additional information, such as a channel state information (CSI) reference signal resource indicator (CRI) or a synchronization signal block (SSB) indicator (SSBI), which corresponds to one or more TCI states. In such aspects, the selected minimum feedback channel offset value indicated in the processing timeline indication may correspond to the one or more TCI states indicated by the CRI and/or the SSBI. More particularly, in some aspects, the network entity 605 may associate the selected minimum feedback channel offset value with one or more TCI states having a source reference signal associated with at least one of the CRI or the SSBI indicated by the L1 beam report. Aspects of the L1 beam report will be described in more detail below in connection with FIG. 7.

As shown by reference number 620, in some aspects, the network entity 605 may provide a feedback indication (e.g., an ACK/NACK indication) associated with the processing timeline indication. For example, if the network entity 605 successfully receives and decodes the processing timeline indication, the UE 120 may receive, from the network entity 605, an ACK indication associated with the processing timeline indication. In some aspects, the ACK indication may be received in the form of the network entity scheduling certain resources or the like in response to the processing timeline indication. More particularly, in aspects in which the processing timeline indication is transmitted using a MAC-CE message, the ACK indication may be indicated by the network entity 605 scheduling a PUSCH transmission with a same hybrid automatic repeat request (HARD) process identifier as a resource in which the MAC-CE message was transmitted by the UE 120. Additionally, or alternatively, the ACK indication may be indicated by a DCI message. For example, the ACK indication may be included in a feedback field (e.g., a field dedicated to providing feedback of UE communications, and, more particularly, a field dedicated to providing feedback of processing timeline indication communications) of a DCI message received from the network entity 605 within a time window after transmitting the processing timeline indication. Additionally, or alternatively, the ACK indication may be included in a DCI message received from the network entity 605 within the time window after transmitting the processing timeline indication by using a predefined combination of information bits in one or more non-feedback fields of the DCI message (e.g., non-feedback fields of the DCI may be repurposed for the ACK indication by including a predefined combination of information bits). Additionally, or alternatively, the ACK indication may be indicated by the network entity 605 transmitting a message reconfiguring an RRC list of multiple feedback channel offset values (e.g., PUCCH-Configuration.dl-DataToUL-Ack), resulting in an updated RRC list of multiple feedback channel offset values, which will be described in more detail below in connection with reference number 625.

On the other hand, if the network entity 605 does not successfully receive and/or decode the processing timeline indication, the UE 120 may receive, from the network entity 605, a NACK indication associated with the processing timeline indication. For example, the NACK indication may be a request for retransmission of the processing timeline indication received from the network entity 605 within a time window after transmitting the processing timeline indication.

As shown by reference number 625, in some aspects, based at least in part on the processing timeline indication, the network entity 605 and/or the UE 120 may reconfigure the RRC list of multiple feedback channel offset values (e.g., PUCCH-Configuration.dl-DataToUL-Ack). For example, in some aspects, the UE 120 may receive, from the network entity 605, a message reconfiguring the RRC list of multiple feedback channel offset values based at least in part on the processing timeline indication, resulting in an updated RRC list of multiple feedback channel offset values. In some aspect, the message reconfiguring the RRC list of multiple feedback channel offsets may be an RRC message, while in some other aspects, the message reconfiguring the RRC list of multiple feedback channel offset values may be a MAC-CE message. In some other aspects, the network entity 605 and the UE 120 may autonomously select an RRC list of multiple feedback channel offset values that will be applicable to future scheduling DCIs. More particularly, in aspects in which the UE 120 received, from the network entity 605, the configuration indicating multiple RRC lists of multiple feedback channel offset values, with each RRC list being associated with a corresponding minimum feedback channel offset value (as described in connection with reference number 610), the network entity 605 and the UE 120 may select a first RRC list, of the multiple RRC lists, to be used based at least in part on the processing timeline indication (e.g., based at least in part on the minimum feedback channel offset value indicated by the processing timeline indication).

As shown by reference number 630, in some aspects, the UE 120 may receive, from the network entity 605, a PUCCH indication that schedules a PUCCH resource for transmitting a feedback communication (e.g., an ACK/NACK message) associated with a PDSCH communication. In some aspects, the PUCCH indication may be based at least in part on the processing timeline indication. More particularly, the PUCCH indication may schedule the PUCCH resource a number of slots after the PDSCH communication that is equal to or greater than the minimum feedback channel offset value indicated by the processing timeline indication. In this way, the UE 120 will have sufficient time to decode the PDSCH communication using a selected decoding process prior to the corresponding PUCCH resource in which the UE 120 may transmit an ACK/NACK message.

More particularly, in some aspects, the PUCCH indication may indicate a selected feedback channel offset value (e.g., a selected K1 value) associated with the PUCCH resource based at least in part on the processing timeline indication. Moreover, the selected feedback channel offset value may be indicated using the DCI message used to schedule the PDSCH communication. More particularly, the selected feedback channel offset value (which, as described above in connection with FIG. 5, may be indicated using the TDRA field in the scheduling DCI (e.g., PDSCH-to-HARQ feedback timing indicator)) may be one of multiple feedback channel offset values associated with the RRC list (e.g., PUCCH-Configuration.dl-DataToUL-Ack) indicated by the TDRA field or the like.

Moreover, in some aspects, the selected feedback channel offset value may be applicable for more than the duration of a transmission time interval (TTI) (e.g., the selected feedback channel offset value may be applicable for more than one slot). That is, in some aspects, the UE 120 may transmit the processing timeline indication only when switching between decoding processes or the like. Thus, the processing timeline indication (and thus the minimum feedback channel offset value) may remain applicable for some period of time longer than a TTI (e.g., the UE 120 need not transmit a separate processing timeline indication for every TTI). Put another way, based at least in part on the processing timeline indication, the network entity 605 may schedule multiple PUCCH resources for providing multiple feedback communications during a time period, with the time period being longer than a duration of one slot.

Relatedly, in some aspects, the UE 120 may be prohibited from switching between minimum feedback channel offset values too frequently (e.g., the UE 120 may be prohibited from switching between decoding processes too frequently). In such aspects, when the UE 120 transmits the processing timeline indication, a prohibit timer may begin to run, and the UE 120 may be prohibited from transmitting another processing timeline indication (e.g., may be prohibited from changing minimum feedback channel offset values) until after the prohibit timer has expired. More particularly, in some aspects, the UE 120 may transmit, to the network entity 605, another processing timeline indication associated with another PDSCH communication, with the other processing timeline indication indicating another minimum feedback channel offset value for processing the other PDSCH communication, and with the other processing timeline indication being transmitted after a prohibit timer has elapsed. In such aspects, the prohibit timer may begin at a time at which the UE 120 transmits the initial processing timeline indication.

In some aspects, the PUCCH indication shown by reference number 630 may schedule a PUCCH resource that is out-of-order with respect another PUCCH resource. More particularly, based at least in part the UE 120 switching between decoding processes (and thus signaling two different minimum feedback channel offset values (e.g., two different minimum K1 values) to the network entity 605), a PUCCH resource corresponding to a later-occurring PDSCH may occur prior to a PUCCH resource corresponding to an earlier-occurring PDSCH. For example, in some aspects, the UE 120 may transmit, to the network entity 605, a second processing timeline indication associated with a second PDSCH communication. The second processing timeline indication may indicate a second minimum feedback channel offset value (e.g., a second minimum K1 value) for processing the second PDSCH communication, which, in some aspects, may be shorter than the previously signaled minimum feedback channel offset value. This may be indicative that the UE 120 switched from a relatively long decoding process (e.g., a decoding process implementing nonlinear demodulation and/or post-processing techniques) to a relatively short decoding process (e.g., a decoding process implementing MMSE demodulation and/or no post-processing techniques). In such aspects, the UE 120 may receive, from the network entity 605, a second PUCCH indication that schedules a second PUCCH resource for transmitting a second feedback communication associated with the second PDSCH communication. Moreover, due to the difference in implemented decoding processes for each PDSCH (and thus the difference in minimum feedback channel offset values associated with each PDSCH), the second PUCCH resource may occur prior to the first PUCCH resource.

In some aspects, a different HARQ codebook may be used for each minimum feedback channel offset value and/or PUCCH resources associated with each minimum feedback channel offset value. More particularly, and returning to the above example in which the UE 120 is scheduled with two PUCCH resources corresponding to two different minimum feedback channel offset values, a first HARQ codebook may be associated with the first PUCCH resource, while a second HARQ codebook that is different from the first HARQ codebook may be associated with the second PUCCH resource.

As indicated above, FIG. 6 is provided as an example. Other examples may differ from what is described with respect to FIG. 6.

FIG. 7 is a diagram illustrating an example 700 associated with a beam reporting process, in accordance with the present disclosure.

In some aspects, the UE 120 may transmit the processing timeline indication as part of an L1 beam report transmitted to the network entity 605 according to a beam reporting process. The beam reporting process may traditionally be used to report certain capabilities of the UE 120 to the network entity 605 for purposes of beam selection or the like, such as by identifying a number of antenna ports associated with the UE 120, an identification of SSBs associated with each port, or the like. In the example shown in FIG. 7, the beam reporting process may additionally, or alternatively, be used to report certain decoding capabilities (e.g., what types of decoding processes the UE 120 is capable of performing) and/or minimum feedback channel offset values corresponding to each decoding process.

More particularly, as shown by reference number 705, and as indicated as step 1 of the beam reporting process, the UE 120 may report to the network entity 605 a capability value list. In some aspects, the UE 120 may report the capability value list after initial access, during a capability exchange phase with the network entity 605. In this example, the capability value set list may include one or more minimum feedback channel values corresponding to different candidate decoding processes that may be performed by the UE 120. More particularly, the UE 120 may transmit, to the network entity 605, a candidate processing timeline indication that indicates multiple minimum feedback channel offset values for processing PDSCH communications, wherein each of the multiple minimum feedback channel offset values is associated with a corresponding decoding process. For example, the UE 120 may report a first minimum feedback channel offset value corresponding to a relatively simple and/or quick decoding process (e.g., a decoding process implementing MMSE demodulation with no post-demodulation processing or the like), and the UE 120 may report a second minimum feedback channel offset value corresponding to a relatively complex and/or lengthy decoding process (e.g., a decoding process implementing nonlinear demodulation and/or or one or more post-demodulation processing techniques, or the like). Accordingly, the network entity 605 becomes aware of the various candidate minimum feedback offset values that may be requested by the UE 120 in an L1 beam report. In step 1, the UE 120 may report additional capabilities of the UE 120 used for beam selection purposes, such as sets of antenna ports at the UE 120 used to receive SSBs or the like.

As shown by reference number 710, and as indicated as step 2 of the beam reporting process, the UE 120 may report to the network entity a capability set identifier along with a CRI and/or an SSBI. In some aspects, the transmission indicated by reference number 710 may be transmitted using a configured beam report occasion (e.g., the transmission indicated by reference number 710 may be transmitted using time and frequency resources configured for the UE 120 to transmit to the network entity 605 an L1 beam report). In that regard, in some aspects, the transmission indicated by reference number 710 may be referred to as an L1 beam report. When used for beam selection or the like, at step 2 the UE 120 may report the capability value set identifier corresponding to the intended port number for a reported downlink reference signal (e.g., an SSB, a CSI reference signal (CSI-RS), or the like). When used for purposes of indicating a requested minimum feedback channel offset value (e.g., when used to provide the processing timeline indication), the L1 beam report may additionally, or alternatively, indicate a selected minimum feedback channel offset value of the multiple minimum feedback channel offset values. Put another way, in the message shown at step 2, the UE 120 may select a minimum feedback channel offset value, from the candidate minimum feedback offset values reported at step 1, to be applied for a TCI state or the like. In some aspects, when the reporting indicated by reference number 710 includes a CRI and/or SSBI, the selected minimum feedback channel offset value may be associated with one or more TCI states having a source reference signal associated with at least one of the CRI or the SSBI indicated by the L1 beam report.

As shown by reference number 715, and as indicated as step 3 of the beam reporting process, the network entity 605 may acknowledge the L1 beam report (e.g., the network entity 605 may transmit an ACK message based at least in part on correctly decoding the L1 beam report). In this way, the message indicated at reference number 715 may correspond to the ACK/NACK indication described in connection with reference number 620. Moreover, in some aspects, the network entity 605 may update configurations (e.g., a K1 value to be used for scheduling PUCCH resources) based on the L1 beam report.

As shown by reference number 720, in some aspects, the network entity 605 and/or the UE 120 may wait until after an application timer has expired before implementing the reported capabilities of the UE 120. The application timer may be a configured period of time that ensures both the network entity 605 and the UE 120 may update settings, configurations, or the like to implement the reported capabilities, such as a new processing timeline (e.g., a new K1 value) indicated by the L1 beam report. For example, the UE 120 and/or the network entity 605 may perform one or more of the reconfiguration processes described above in connection with reference number 625 during the application timer. More particularly, in aspects in which the UE 120 receives a configuration indicating multiple RRC lists of multiple feedback channel offset values, with the UE 120 and the network entity 605 autonomously selecting a first RRC list, of the multiple RRC lists, associated with the PUCCH resource based at least in part on the processing timeline indication, the first RRC list may apply after an expiration of an application timer. In some aspects, the application timer may begin at a time at which the UE 120 receives an ACK message acknowledging the processing timeline indication. In some other aspects, the application timer may begin at a time at which the UE 120 transmits the processing timeline indication.

As shown by reference number 725, and as indicated as step 4 of the beam reporting process, once the application timer has elapsed (when applicable), the network entity 605 may schedule a PDSCH communication and a corresponding PUCCH resource based at least in part on the L1 beam report. More particularly, the network entity 605 may schedule a PDSCH communication and a corresponding PUCCH resource for providing a feedback communication associated with the PDSCH communication, with the PUCCH resource being based at least in part on the processing timeline indication included in the L1 beam report (e.g., the network entity 605 may indicate a corresponding K1 that is long enough for the UE 120 to perform the selected decoding process). In this way, the message indicated at reference number 725 may correspond to the PUCCH indication described in connection with reference number 630. The message shown by reference number 725 may include additional indications associated with a beam selection procedure. For example, the network entity 605 may schedule an SRS and/or PUSCH for coordinated beamforming transmission on the corresponding TCI state, based on the reported capability, or the like using the message indicated by reference number 725.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with a processing timeline indication for scheduling a feedback resource.

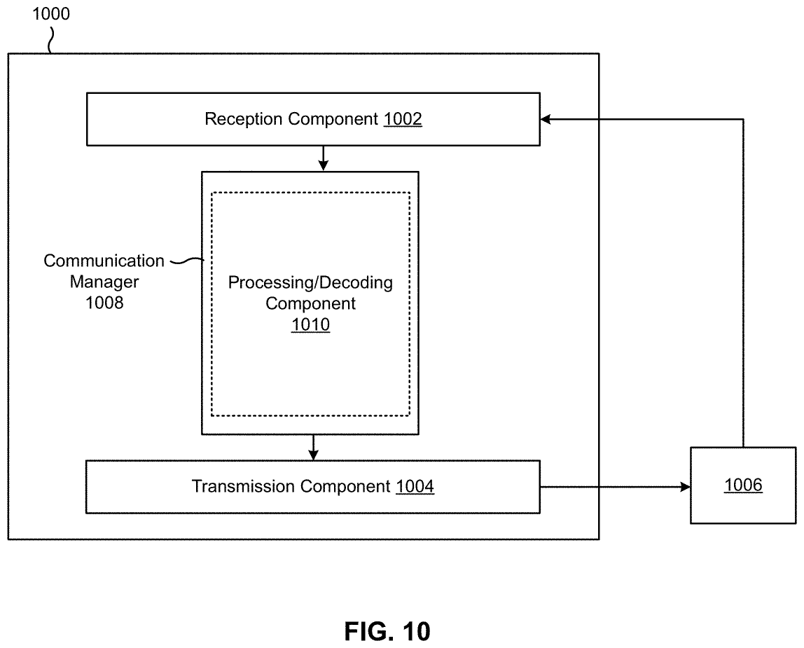

As shown in FIG. 8, in some aspects, process 800 may include transmitting, to a network entity (e.g., network entity 605), a processing timeline indication associated with a PDSCH communication, wherein the processing timeline indication indicates a minimum feedback channel offset value for processing the PDSCH communication (block 810). For example, the UE (e.g., using communication manager 1008 and/or transmission component 1004, depicted in FIG. 10) may transmit, to a network entity, a processing timeline indication associated with a PDSCH communication, wherein the processing timeline indication indicates a minimum feedback channel offset value for processing the PDSCH communication, as described above.

As further shown in FIG. 8, in some aspects, process 800 may include receiving, from the network entity, a PUCCH indication that schedules a PUCCH resource for transmitting a feedback communication associated with the PDSCH communication, wherein the PUCCH indication is based at least in part on the processing timeline indication (block 820). For example, the UE (e.g., using communication manager 1008 and/or reception component 1002, depicted in FIG. 10) may receive, from the network entity, a PUCCH indication that schedules a PUCCH resource for transmitting a feedback communication associated with the PDSCH communication, wherein the PUCCH indication is based at least in part on the processing timeline indication, as described above.

Process 800 may include additional aspects, such as any single aspect or any combination of aspects described below and/or in connection with one or more other processes described elsewhere herein.

In a first aspect, based at least in part on the processing timeline indication, the network entity schedules multiple PUCCH resources for providing multiple feedback communications during a time period, and the time period is longer than a duration of one slot.

In a second aspect, alone or in combination with the first aspect, the processing timeline indication is transmitted using a MAC-CE message.

In a third aspect, alone or in combination with one or more of the first and second aspects, process 800 includes transmitting, to the network entity, a scheduling request associated with the processing timeline indication, and receiving, from the network entity, a MAC-CE resource indication scheduling a resource for transmitting the MAC-CE message.

In a fourth aspect, alone or in combination with one or more of the first through third aspects, the MAC-CE message is transmitted using a configured grant resource.

In a fifth aspect, alone or in combination with one or more of the first through fourth aspects, the minimum feedback channel offset value is associated with a TCI state of a resource used to transmit the MAC-CE message.

In a sixth aspect, alone or in combination with one or more of the first through fifth aspects, the minimum feedback channel offset value is associated with a TCI state indicated by the processing timeline indication.

In a seventh aspect, alone or in combination with one or more of the first through sixth aspects, the processing timeline indication is transmitted using an L1 beam report.

In an eighth aspect, alone or in combination with one or more of the first through seventh aspects, process 800 includes transmitting, to the network entity, a candidate processing timeline indication that indicates multiple minimum feedback channel offset values for processing PDSCH communications, wherein each of the multiple minimum feedback channel offset values is associated with a corresponding decoding process.

In a ninth aspect, alone or in combination with one or more of the first through eighth aspects, the processing timeline indication indicates a selected minimum feedback channel offset value of the multiple minimum feedback channel offset values.

In a tenth aspect, alone or in combination with one or more of the first through ninth aspects, the selected minimum feedback channel offset value is associated with one or more TCI states having a source reference signal associated with at least one of a CRI or an SSBI indicated by the L1 beam report.

In an eleventh aspect, alone or in combination with one or more of the first through tenth aspects, the PUCCH indication indicates a selected feedback channel offset value associated with the PUCCH resource based at least in part on the processing timeline indication, wherein the selected feedback channel offset value is one of multiple feedback channel offset values associated with an RRC list.

In a twelfth aspect, alone or in combination with one or more of the first through eleventh aspects, the PUCCH indication is received in a DCI message scheduling the PDSCH communication.

In a thirteenth aspect, alone or in combination with one or more of the first through twelfth aspects, process 800 includes receiving, from the network entity, a message reconfiguring an RRC list of multiple feedback channel offset values based at least in part on the processing timeline indication, resulting in an updated RRC list of multiple feedback channel offset values.

In a fourteenth aspect, alone or in combination with one or more of the first through thirteenth aspects, the message reconfiguring the RRC list of multiple feedback channel offsets is an RRC message.

In a fifteenth aspect, alone or in combination with one or more of the first through fourteenth aspects, the message reconfiguring the RRC list of multiple feedback channel offset values is a MAC-CE message.

In a sixteenth aspect, alone or in combination with one or more of the first through fifteenth aspects, process 800 includes receiving, from the network entity, a configuration indicating multiple RRC lists of multiple feedback channel offset values, wherein each RRC list is associated with a corresponding minimum feedback channel offset value, and wherein the UE and the network entity autonomously select a first RRC list, of the multiple RRC lists, associated with the PUCCH resource based at least in part on the processing timeline indication.

In a seventeenth aspect, alone or in combination with one or more of the first through sixteenth aspects, the first RRC list applies after an expiration of an application timer.

In an eighteenth aspect, alone or in combination with one or more of the first through seventeenth aspects, process 800 includes receiving, from the network entity, an ACK message associated with the processing timeline indication, wherein the application timer begins at a time at which the UE receives the ACK message.

In a nineteenth aspect, alone or in combination with one or more of the first through eighteenth aspects, the application timer begins at a time at which the UE transmits the processing timeline indication.

In a twentieth aspect, alone or in combination with one or more of the first through nineteenth aspects, process 800 includes receiving, from the network entity, an ACK indication associated with the processing timeline indication.

In a twenty-first aspect, alone or in combination with one or more of the first through twentieth aspects, the processing timeline indication is transmitted using a MAC-CE message, and the ACK indication is indicated by the network entity scheduling a PUSCH transmission with a same HARQ process identifier as a resource in which the MAC-CE message was transmitted.

In a twenty-second aspect, alone or in combination with one or more of the first through twenty-first aspects, the ACK indication is included in a feedback field of a DCI message received from the network entity within a time window after transmitting the processing timeline indication.

In a twenty-third aspect, alone or in combination with one or more of the first through twenty-second aspects, the ACK indication is included in a DCI message received from the network entity within a time window after transmitting the processing timeline indication, and the ACK indication is indicated using a combination of information bits in one or more non-feedback fields of the DCI message.

In a twenty-fourth aspect, alone or in combination with one or more of the first through twenty-third aspects, the ACK indication is indicated by the network entity transmitting a message reconfiguring an RRC list of multiple feedback channel offset values, resulting in an updated RRC list of multiple feedback channel offset values.

In a twenty-fifth aspect, alone or in combination with one or more of the first through twenty-fourth aspects, process 800 includes receiving, from the network entity, a NACK indication associated with the processing timeline indication.

In a twenty-sixth aspect, alone or in combination with one or more of the first through twenty-fifth aspects, the NACK indication is a request for retransmission received from the network entity within a time window after transmitting the processing timeline indication.

In a twenty-seventh aspect, alone or in combination with one or more of the first through twenty-sixth aspects, process 800 includes transmitting, to the network entity, another processing timeline indication associated with another PDSCH communication, wherein the other processing timeline indication indicates another minimum feedback channel offset value for processing the other PDSCH communication, wherein the other processing timeline indication is transmitted after a prohibit timer has elapsed, and wherein the prohibit timer begins at a time at which the UE transmits the processing timeline indication.

In a twenty-eighth aspect, alone or in combination with one or more of the first through twenty-seventh aspects, process 800 includes transmitting, to the network entity, another processing timeline indication associated with another PDSCH communication, wherein the other processing timeline indication indicates another minimum feedback channel offset value for processing the other PDSCH communication, and receiving, from the network entity, another PUCCH indication that schedules another PUCCH resource for transmitting another feedback communication associated with the other PDSCH communication, wherein the other PUCCH indication is based at least in part on the other processing timeline indication, and wherein the other PUCCH resource occurs prior to the PUCCH resource.

In a twenty-ninth aspect, alone or in combination with one or more of the first through twenty-eight aspects, a first HARQ codebook is associated with the PUCCH resource, and a second HARQ codebook that is different from the first HARQ codebook is associated with the other PUCCH resource.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network entity 605) performs operations associated with a processing timeline indication for scheduling a feedback resource.

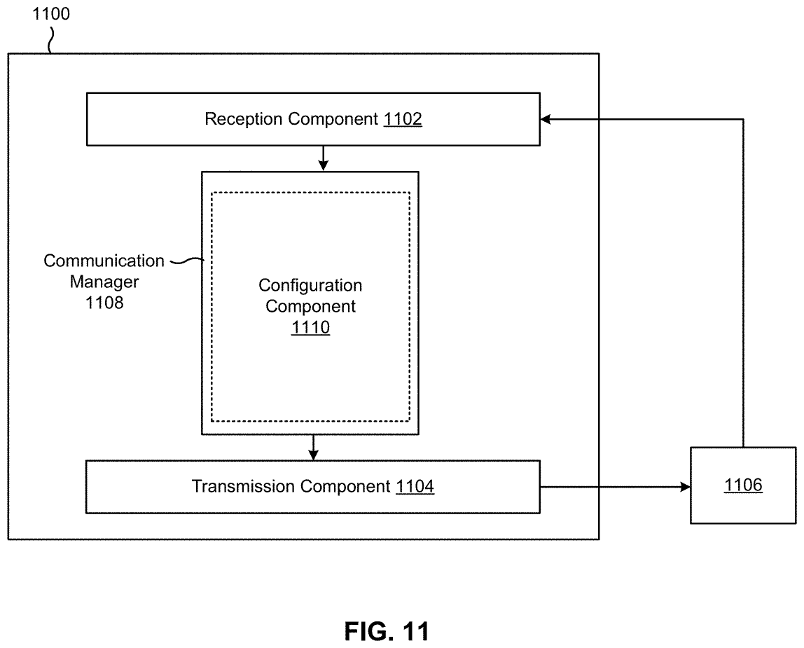

As shown in FIG. 9, in some aspects, process 900 may include receiving, from a UE (e.g., UE 120), a processing timeline indication associated with a PDSCH communication, wherein the processing timeline indication indicates a minimum feedback channel offset value for processing the PDSCH communication (block 910). For example, the network entity (e.g., using communication manager 1108 and/or reception component 1102, depicted in FIG. 11) may receive, from a UE, a processing timeline indication associated with a PDSCH communication, wherein the processing timeline indication indicates a minimum feedback channel offset value for processing the PDSCH communication, as described above.

As further shown in FIG. 9, in some aspects, process 900 may include transmitting, to the UE, a PUCCH indication that schedules a PUCCH resource for transmitting a feedback communication associated with the PDSCH communication, wherein the PUCCH indication is based at least in part on the processing timeline indication (block 920). For example, the network entity (e.g., using communication manager 1108 and/or transmission component 1104, depicted in FIG. 11) may transmit, to the UE, a PUCCH indication that schedules a PUCCH resource for transmitting a feedback communication associated with the PDSCH communication, wherein the PUCCH indication is based at least in part on the processing timeline indication, as described above.

Process 900 may include additional aspects, such as any single aspect or any combination of aspects described below and/or in connection with one or more other processes described elsewhere herein.

In a first aspect, based at least in part on the processing timeline indication, the network entity schedules multiple PUCCH resources for providing multiple feedback communications during a time period, and the time period is longer than a duration of one slot.

In a second aspect, alone or in combination with the first aspect, the processing timeline indication is received via a MAC-CE message.

In a third aspect, alone or in combination with one or more of the first and second aspects, process 900 includes receiving, from the UE, a scheduling request associated with the processing timeline indication, and transmitting, to the UE, a MAC-CE resource indication scheduling a resource for transmitting the MAC-CE message.

In a fourth aspect, alone or in combination with one or more of the first through third aspects, the MAC-CE message is received via a configured grant resource.

In a fifth aspect, alone or in combination with one or more of the first through fourth aspects, the minimum feedback channel offset value is associated with a TCI state of a resource used to transmit the MAC-CE message.

In a sixth aspect, alone or in combination with one or more of the first through fifth aspects, the minimum feedback channel offset value is associated with a TCI state indicated by the processing timeline indication.

In a seventh aspect, alone or in combination with one or more of the first through sixth aspects, the processing timeline indication is received via a L1 beam report.

In an eighth aspect, alone or in combination with one or more of the first through seventh aspects, process 900 includes receiving, from the UE, a candidate processing timeline indication that indicates multiple minimum feedback channel offset values for processing PDSCH communications, wherein each of the multiple minimum feedback channel offset values is associated with a corresponding decoding process.

In a ninth aspect, alone or in combination with one or more of the first through eighth aspects, the processing timeline indication indicates a selected minimum feedback channel offset value of the multiple minimum feedback channel offset values.

In a tenth aspect, alone or in combination with one or more of the first through ninth aspects, the selected minimum feedback channel offset value is associated with one or more TCI states having a source reference signal associated with at least one of a CRI or an SSBI indicator indicated by the L1 beam report.

In an eleventh aspect, alone or in combination with one or more of the first through tenth aspects, the PUCCH indication indicates a selected feedback channel offset value associated with the PUCCH resource based at least in part on the processing timeline indication, and the selected feedback channel offset value is one of multiple feedback channel offset values associated with an RRC list.

In a twelfth aspect, alone or in combination with one or more of the first through eleventh aspects, the PUCCH indication is received in a DCI message scheduling the PDSCH communication.

In a thirteenth aspect, alone or in combination with one or more of the first through twelfth aspects, process 900 includes transmitting, to the UE, a message reconfiguring an RRC list of multiple feedback channel offset values based at least in part on the processing timeline indication, resulting in an updated RRC list of multiple feedback channel offset values.

In a fourteenth aspect, alone or in combination with one or more of the first through thirteenth aspects, the message reconfiguring the RRC list of multiple feedback channel offsets is an RRC message.

In a fifteenth aspect, alone or in combination with one or more of the first through fourteenth aspects, the message reconfiguring the RRC list of multiple feedback channel offset values is a MAC-CE message.

In a sixteenth aspect, alone or in combination with one or more of the first through fifteenth aspects, process 900 includes transmitting, to the UE, a configuration indicating multiple RRC lists of multiple feedback channel offset values, wherein each RRC list is associated with a corresponding minimum feedback channel offset value, and wherein the UE and the network entity autonomously select a first RRC list, of the multiple RRC lists, associated with the PUCCH resource based at least in part on the processing timeline indication.

In a seventeenth aspect, alone or in combination with one or more of the first through sixteenth aspects, the first RRC list applies after an expiration of an application timer.

In an eighteenth aspect, alone or in combination with one or more of the first through seventeenth aspects, process 900 includes transmitting, to the UE, an ACK message associated with the processing timeline indication, wherein the application timer begins at a time at which the UE receives the ACK message.

In a nineteenth aspect, alone or in combination with one or more of the first through eighteenth aspects, the application timer begins at a time at which the UE transmits the processing timeline indication.

In a twentieth aspect, alone or in combination with one or more of the first through nineteenth aspects, process 900 includes transmitting, to the UE, an ACK indication associated with the processing timeline indication.

In a twenty-first aspect, alone or in combination with one or more of the first through twentieth aspects, the processing timeline indication is received via a MAC-CE message, and the ACK indication is indicated by the network entity scheduling the PUCCH resource with a same HARQ process identifier as a resource in which the MAC-CE message was received.

In a twenty-second aspect, alone or in combination with one or more of the first through twenty-first aspects, the ACK indication is included in a feedback field of a DCI message transmitted by the network entity within a time window after the UE transmits the processing timeline indication.

In a twenty-third aspect, alone or in combination with one or more of the first through twenty-second aspects, the ACK indication is included in a DCI message transmitted by the network entity within a time window after the UE transmits the processing timeline indication, and the ACK indication is indicated using a combination of information bits in one or more non-feedback fields of the DCI message.

In a twenty-fourth aspect, alone or in combination with one or more of the first through twenty-third aspects, the ACK indication is indicated by the network entity transmitting a message reconfiguring an RRC list of multiple feedback channel offset values, resulting in an updated RRC list of multiple feedback channel offset values.

In a twenty-fifth aspect, alone or in combination with one or more of the first through twenty-fourth aspects, process 900 includes transmitting, to the UE, a NACK indication associated with the processing timeline indication.

In a twenty-sixth aspect, alone or in combination with one or more of the first through twenty-fifth aspects, the NACK indication is a request for retransmission transmitted by the network entity within a time window after the UE transmits the processing timeline indication.

In a twenty-seventh aspect, alone or in combination with one or more of the first through twenty-sixth aspects, process 900 includes receiving, from the UE, another processing timeline indication associated with another PDSCH communication, wherein the other processing timeline indication indicates another minimum feedback channel offset value for processing the other PDSCH communication, wherein the other processing timeline indication is transmitted after a prohibit timer has elapsed, and wherein the prohibit timer begins at a time at which the UE transmits the processing timeline indication.

In a twenty-eighth aspect, alone or in combination with one or more of the first through twenty-seventh aspects, process 900 includes receiving, from the UE, another processing timeline indication associated with another PDSCH communication, wherein the other processing timeline indication indicates another minimum feedback channel offset value for processing the other PDSCH communication, and transmitting, to the UE, another PUCCH indication that schedules another PUCCH resource for transmitting another feedback communication associated with the other PDSCH communication, wherein the other PUCCH indication is based at least in part on the other processing timeline indication, and wherein the other PUCCH resource occurs prior to the PUCCH resource.

In a twenty-ninth aspect, alone or in combination with one or more of the first through twenty-eighth aspects, a first HARQ codebook is associated with the PUCCH resource, and a second HARQ codebook that is different from the first HARQ codebook is associated with the other PUCCH resource.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the disclosure. The apparatus 1000 may be a UE (e.g., UE 120), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008 (e.g., communication manager 140). The communication manager 1008 may include a processing/decoding component 1010, among other examples.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE 120 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE 120 described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE 120 described in connection with FIG. 2. In some aspects, the transmission component 1004 may be co-located with the reception component 1002 in a transceiver.

The transmission component 1004 and/or the processing/decoding component 1010 may transmit, to a network entity (e.g., network entity 605), a processing timeline indication associated with a PDSCH communication, wherein the processing timeline indication indicates a minimum feedback channel offset value for processing the PDSCH communication. The reception component 1002 may receive, from the network entity, a PUCCH indication that schedules a PUCCH resource for transmitting a feedback communication associated with the PDSCH communication, wherein the PUCCH indication is based at least in part on the processing timeline indication.

The transmission component 1004 may transmit, to the network entity, a scheduling request associated with the processing timeline indication.

The reception component 1002 may receive, from the network entity, a MAC-CE resource indication scheduling a resource for transmitting the MAC-CE message.

The transmission component 1004 and/or the processing/decoding component 1010 may transmit, to the network entity, a candidate processing timeline indication that indicates multiple minimum feedback channel offset values for processing PDSCH communications, wherein each of the multiple minimum feedback channel offset values is associated with a corresponding decoding process.

The reception component 1002 may receive, from the network entity, a message reconfiguring an RRC list of multiple feedback channel offset values based at least in part on the processing timeline indication, resulting in an updated RRC list of multiple feedback channel offset values.

The reception component 1002 may receive, from the network entity, a configuration indicating multiple RRC lists of multiple feedback channel offset values, wherein each RRC list is associated with a corresponding minimum feedback channel offset value, and wherein the UE and the network entity autonomously select a first RRC list, of the multiple RRC lists, associated with the PUCCH resource based at least in part on the processing timeline indication.

The reception component 1002 may receive, from the network entity, an ACK message associated with the processing timeline indication, wherein the application timer begins at a time at which the UE receives the ACK message.

The reception component 1002 may receive, from the network entity, an ACK indication associated with the processing timeline indication.

The reception component 1002 may receive, from the network entity, a NACK indication associated with the processing timeline indication.

The transmission component 1004 and/or the processing/decoding component 1010 may transmit, to the network entity, another processing timeline indication associated with another PDSCH communication, wherein the other processing timeline indication indicates another minimum feedback channel offset value for processing the other PDSCH communication, wherein the other processing timeline indication is transmitted after a prohibit timer has elapsed, and wherein the prohibit timer begins at a time at which the UE transmits the processing timeline indication.

The transmission component 1004 and/or the processing/decoding component 1010 may transmit, to the network entity, another processing timeline indication associated with another PDSCH communication, wherein the other processing timeline indication indicates another minimum feedback channel offset value for processing the other PDSCH communication receiving, from the network entity, another PUCCH indication that schedules another PUCCH resource for transmitting another feedback communication associated with the other PDSCH communication, wherein the other PUCCH indication is based at least in part on the other processing timeline indication, and wherein the other PUCCH resource occurs prior to the PUCCH resource.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network entity (e.g., network entity 605), or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 1108 (e.g., the communication manager 150). The communication manager 1108 may include a configuration component 1110, among other examples.

In some aspects, the apparatus 1100 may be configured to perform one or more operations described herein in connection with FIGS. 6-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the base station 110 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station 110 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station 110 described in connection with FIG. 2. In some aspects, the transmission component 1104 may be co-located with the reception component 1102 in a transceiver.

The reception component 1102 may receive, from a UE (e.g., UE 120), a processing timeline indication associated with a PDSCH communication, wherein the processing timeline indication indicates a minimum feedback channel offset value for processing the PDSCH communication. The transmission component 1104 and/or the configuration component 1110 may transmit, to the UE, a PUCCH indication that schedules a PUCCH resource for transmitting a feedback communication associated with the PDSCH communication, wherein the PUCCH indication is based at least in part on the processing timeline indication.

The reception component 1102 may receive, from the UE, a scheduling request associated with the processing timeline indication.

The transmission component 1104 and/or the configuration component 1110 may transmit, to the UE, a MAC-CE resource indication scheduling a resource for transmitting the MAC-CE message.

The reception component 1102 may receive, from the UE, a candidate processing timeline indication that indicates multiple minimum feedback channel offset values for processing PDSCH communications, wherein each of the multiple minimum feedback channel offset values is associated with a corresponding decoding process.

The transmission component 1104 and/or the configuration component 1110 may transmit, to the UE, a message reconfiguring an RRC list of multiple feedback channel offset values based at least in part on the processing timeline indication, resulting in an updated RRC list of multiple feedback channel offset values.

The transmission component 1104 and/or the configuration component 1110 may transmit, to the UE, a configuration indicating multiple RRC lists of multiple feedback channel offset values, wherein each RRC list is associated with a corresponding minimum feedback channel offset value, and wherein the UE and the network entity autonomously select a first RRC list, of the multiple RRC lists, associated with the PUCCH resource based at least in part on the processing timeline indication.

The transmission component 1104 may transmit, to the UE, an ACK message associated with the processing timeline indication, wherein the application timer begins at a time at which the UE receives the ACK message.

The transmission component 1104 may transmit, to the UE, an ACK indication associated with the processing timeline indication.

The transmission component 1104 may transmit, to the UE, a NACK indication associated with the processing timeline indication.

The reception component 1102 may receive, from the UE, another processing timeline indication associated with another PDSCH communication, wherein the other processing timeline indication indicates another minimum feedback channel offset value for processing the other PDSCH communication, wherein the other processing timeline indication is transmitted after a prohibit timer has elapsed, and wherein the prohibit timer begins at a time at which the UE transmits the processing timeline indication.

The reception component 1102 may receive, from the UE, another processing timeline indication associated with another PDSCH communication, wherein the other processing timeline indication indicates another minimum feedback channel offset value for processing the other PDSCH communication transmitting, to the UE, another PUCCH indication that schedules another PUCCH resource for transmitting another feedback communication associated with the other PDSCH communication, wherein the other PUCCH indication is based at least in part on the other processing timeline indication, and wherein the other PUCCH resource occurs prior to the PUCCH resource.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: transmitting, to a network entity, a processing timeline indication associated with a PDSCH communication, wherein the processing timeline indication indicates a minimum feedback channel offset value for processing the PDSCH communication; and receiving, from the network entity, a PUCCH indication that schedules a PUCCH resource for transmitting a feedback communication associated with the PDSCH communication, wherein the PUCCH indication is based at least in part on the processing timeline indication.

Aspect 2: The method of Aspect 1, wherein, based at least in part on the processing timeline indication, the network entity schedules multiple PUCCH resources for providing multiple feedback communications during a time period, wherein the time period is longer than a duration of one slot.

Aspect 3: The method of any of Aspects 1-2, wherein the processing timeline indication is transmitted using a MAC-CE message.

Aspect 4: The method of Aspect 3, further comprising: transmitting, to the network entity, a scheduling request associated with the processing timeline indication; and receiving, from the network entity, a MAC-CE resource indication scheduling a resource for transmitting the MAC-CE message.

Aspect 5: The method of any of Aspects 3-4, wherein the MAC-CE message is transmitted using a configured grant resource.

Aspect 6: The method of any of Aspects 3-5, wherein the minimum feedback channel offset value is associated with a TCI state of a resource used to transmit the MAC-CE message.

Aspect 7: The method of any of Aspects 1-6, wherein the minimum feedback channel offset value is associated with a TCI state indicated by the processing timeline indication.

Aspect 8: The method of any of Aspects 1-7, wherein the processing timeline indication is transmitted using an L1 beam report.

Aspect 9: The method of Aspect 8, further comprising transmitting, to the network entity, a candidate processing timeline indication that indicates multiple minimum feedback channel offset values for processing PDSCH communications, wherein each of the multiple minimum feedback channel offset values is associated with a corresponding decoding process.

Aspect 10: The method of Aspect 9, wherein the processing timeline indication indicates a selected minimum feedback channel offset value of the multiple minimum feedback channel offset values.

Aspect 11: The method of Aspect 10, wherein the selected minimum feedback channel offset value is associated with one or more TCI states having a source reference signal associated with at least one of a CRI or an SSBI indicated by the L1 beam report.

Aspect 12: The method of any of Aspects 1-11, wherein the PUCCH indication indicates a selected feedback channel offset value associated with the PUCCH resource based at least in part on the processing timeline indication, wherein the selected feedback channel offset value is one of multiple feedback channel offset values associated with an RRC list.

Aspect 13: The method of Aspect 12, wherein the PUCCH indication is received in a DCI message scheduling the PDSCH communication.

Aspect 14: The method of any of Aspects 1-13, further comprising receiving, from the network entity, a message reconfiguring an RRC list of multiple feedback channel offset values based at least in part on the processing timeline indication, resulting in an updated RRC list of multiple feedback channel offset values.

Aspect 15: The method of Aspect 14, wherein the message reconfiguring the RRC list of multiple feedback channel offsets is an RRC message.

Aspect 16: The method of Aspect 14, wherein the message reconfiguring the RRC list of multiple feedback channel offset values is a MAC-CE message.

Aspect 17: The method of any of Aspects 1-16, further comprising receiving, from the network entity, a configuration indicating multiple RRC lists of multiple feedback channel offset values, wherein each RRC list is associated with a corresponding minimum feedback channel offset value, and wherein the UE and the network entity autonomously select a first RRC list, of the multiple RRC lists, associated with the PUCCH resource based at least in part on the processing timeline indication.

Aspect 18: The method of Aspect 17, wherein the first RRC list applies after an expiration of an application timer.

Aspect 19: The method of Aspect 18, further comprising receiving, from the network entity, an ACK message associated with the processing timeline indication, wherein the application timer begins at a time at which the UE receives the ACK message.

Aspect 20: The method of Aspect 18, wherein the application timer begins at a time at which the UE transmits the processing timeline indication.

Aspect 21: The method of any of Aspects 1-20, further comprising receiving, from the network entity, an ACK indication associated with the processing timeline indication.

Aspect 22: The method of Aspect 21, wherein the processing timeline indication is transmitted using a MAC-CE message, and wherein the ACK indication is indicated by the network entity scheduling a PUSCH transmission with a same HARQ process identifier as a resource in which the MAC-CE message was transmitted.

Aspect 23: The method of Aspect 21, wherein the ACK indication is included in a feedback field of a DCI message received from the network entity within a time window after transmitting the processing timeline indication.

Aspect 24: The method of Aspect 21, wherein the ACK indication is included in a DCI message received from the network entity within a time window after transmitting the processing timeline indication, and wherein the ACK indication is indicated using a combination of information bits in one or more non-feedback fields of the DCI message.

Aspect 25: The method of Aspect 21, wherein the ACK indication is indicated by the network entity transmitting a message reconfiguring an RRC list of multiple feedback channel offset values, resulting in an updated RRC list of multiple feedback channel offset values.

Aspect 26: The method of any of Aspects 1-25, further comprising receiving, from the network entity, a NACK indication associated with the processing timeline indication.

Aspect 27: The method of Aspect 26, wherein the NACK indication is a request for retransmission received from the network entity within a time window after transmitting the processing timeline indication.

Aspect 28: The method of any of Aspects 1-27, further comprising transmitting, to the network entity, another processing timeline indication associated with another PDSCH communication, wherein the other processing timeline indication indicates another minimum feedback channel offset value for processing the other PDSCH communication, wherein the other processing timeline indication is transmitted after a prohibit timer has elapsed, and wherein the prohibit timer begins at a time at which the UE transmits the processing timeline indication.

Aspect 29: The method of any of Aspects 1-28, further comprising transmitting, to the network entity, another processing timeline indication associated with another PDSCH communication, wherein the other processing timeline indication indicates another minimum feedback channel offset value for processing the other PDSCH communication; and receiving, from the network entity, another PUCCH indication that schedules another PUCCH resource for transmitting another feedback communication associated with the other PDSCH communication, wherein the other PUCCH indication is based at least in part on the other processing timeline indication, and wherein the other PUCCH resource occurs prior to the PUCCH resource.

Aspect 30: The method of Aspect 29, wherein a first HARQ codebook is associated with the PUCCH resource, and wherein a second HARQ codebook that is different from the first HARQ codebook is associated with the other PUCCH resource.

Aspect 31: A method of wireless communication performed by a network entity, comprising: receiving, from a UE, a processing timeline indication associated with a PDSCH communication, wherein the processing timeline indication indicates a minimum feedback channel offset value for processing the PDSCH communication; and transmitting, to the UE, a PUCCH indication that schedules a PUCCH resource for transmitting a feedback communication associated with the PDSCH communication, wherein the PUCCH indication is based at least in part on the processing timeline indication.

Aspect 32: The method of Aspect 31, wherein, based at least in part on the processing timeline indication, the network entity schedules multiple PUCCH resources for providing multiple feedback communications during a time period, wherein the time period is longer than a duration of one slot.

Aspect 33: The method of any of Aspects 31-32, wherein the processing timeline indication is received via a MAC-CE message.

Aspect 34: The method of Aspect 33, further comprising: receiving, from the UE, a scheduling request associated with the processing timeline indication; and transmitting, to the UE, a MAC-CE resource indication scheduling a resource for transmitting the MAC-CE message.

Aspect 35: The method of any of Aspects 33-34, wherein the MAC-CE message is received via a configured grant resource.

Aspect 36: The method of any of Aspects 33-35, wherein the minimum feedback channel offset value is associated with a TCI state of a resource used to transmit the MAC-CE message.

Aspect 37: The method of any of Aspects 31-36, wherein the minimum feedback channel offset value is associated with a TCI state indicated by the processing timeline indication.

Aspect 38: The method of any of Aspects 31-37, wherein the processing timeline indication is received via an L1 beam report.

Aspect 39: The method of Aspect 38, further comprising receiving, from the UE, a candidate processing timeline indication that indicates multiple minimum feedback channel offset values for processing PDSCH communications, wherein each of the multiple minimum feedback channel offset values is associated with a corresponding decoding process.

Aspect 40: The method of Aspect 39, wherein the processing timeline indication indicates a selected minimum feedback channel offset value of the multiple minimum feedback channel offset values.

Aspect 41: The method of Aspect 40, wherein the selected minimum feedback channel offset value is associated with one or more TCI states having a source reference signal associated with at least one of a CRI or an SSBI indicated by the L1 beam report.

Aspect 42: The method of any of Aspects 31-41, wherein the PUCCH indication indicates a selected feedback channel offset value associated with the PUCCH resource based at least in part on the processing timeline indication, wherein the selected feedback channel offset value is one of multiple feedback channel offset values associated with an RRC list.

Aspect 43: The method of Aspect 42, wherein the PUCCH indication is received in a DCI message scheduling the PDSCH communication.

Aspect 44: The method of any of Aspects 31-43, further comprising transmitting, to the UE, a message reconfiguring an RRC list of multiple feedback channel offset values based at least in part on the processing timeline indication, resulting in an updated RRC list of multiple feedback channel offset values.

Aspect 45: The method of Aspect 44, wherein the message reconfiguring the RRC list of multiple feedback channel offsets is an RRC message.

Aspect 46: The method of Aspect 44, wherein the message reconfiguring the RRC list of multiple feedback channel offset values is a MAC-CE message.

Aspect 47: The method of any of Aspects 31-46, further comprising transmitting, to the UE, a configuration indicating multiple RRC lists of multiple feedback channel offset values, wherein each RRC list is associated with a corresponding minimum feedback channel offset value, and wherein the UE and the network entity autonomously select a first RRC list, of the multiple RRC lists, associated with the PUCCH resource based at least in part on the processing timeline indication.

Aspect 48: The method of Aspect 47, wherein the first RRC list applies after an expiration of an application timer.

Aspect 49: The method of Aspect 48, further comprising transmitting, to the UE, an ACK message associated with the processing timeline indication, wherein the application timer begins at a time at which the UE receives the ACK message.

Aspect 50: The method of Aspect 48, wherein the application timer begins at a time at which the UE transmits the processing timeline indication.

Aspect 51: The method of any of Aspects 31-50, further comprising transmitting, to the UE, an ACK indication associated with the processing timeline indication.

Aspect 52: The method of Aspect 51, wherein the processing timeline indication is received via a MAC-CE message, and wherein the ACK indication is indicated by the network entity scheduling the PUCCH resource with a same HARQ process identifier as a resource in which the MAC-CE message was received.

Aspect 53: The method of Aspect 51, wherein the ACK indication is included in a feedback field of a DCI message transmitted by the network entity within a time window after the UE transmits the processing timeline indication.

Aspect 54: The method of Aspect 51, wherein the ACK indication is included in a DCI message transmitted by the network entity within a time window after the UE transmits the processing timeline indication, and wherein the ACK indication is indicated using a combination of information bits in one or more non-feedback fields of the DCI message.

Aspect 55: The method of Aspect 51, wherein the ACK indication is indicated by the network entity transmitting a message reconfiguring an RRC list of multiple feedback channel offset values, resulting in an updated RRC list of multiple feedback channel offset values.

Aspect 56: The method of any of Aspects 31-55, further comprising transmitting, to the UE, a NACK indication associated with the processing timeline indication.

Aspect 57: The method of Aspect 56, wherein the NACK indication is a request for retransmission transmitted by the network entity within a time window after the UE transmits the processing timeline indication.

Aspect 58: The method of any of Aspects 31-57, further comprising receiving, from the UE, another processing timeline indication associated with another PDSCH communication, wherein the other processing timeline indication indicates another minimum feedback channel offset value for processing the other PDSCH communication, wherein the other processing timeline indication is transmitted after a prohibit timer has elapsed, and wherein the prohibit timer begins at a time at which the UE transmits the processing timeline indication.

Aspect 59: The method of any of Aspects 31-58, further comprising receiving, from the UE, another processing timeline indication associated with another PDSCH communication, wherein the other processing timeline indication indicates another minimum feedback channel offset value for processing the other PDSCH communication; and transmitting, to the UE, another PUCCH indication that schedules another PUCCH resource for transmitting another feedback communication associated with the other PDSCH communication, wherein the other PUCCH indication is based at least in part on the other processing timeline indication, and wherein the other PUCCH resource occurs prior to the PUCCH resource.

Aspect 60: The method of Aspect 59, wherein a first HARQ codebook is associated with the PUCCH resource, and wherein a second HARQ codebook that is different from the first HARQ codebook is associated with the other PUCCH resource.

Aspect 61: An apparatus for wireless communication at a device, comprising a processor; memory coupled with the processor; and instructions stored in the memory and executable by the processor to cause the apparatus to perform the method of one or more of Aspects 1-30.

Aspect 62: A device for wireless communication, comprising a memory and one or more processors coupled to the memory, the one or more processors configured to perform the method of one or more of Aspects 1-30.

Aspect 63: An apparatus for wireless communication, comprising at least one means for performing the method of one or more of Aspects 1-30.

Aspect 64: A non-transitory computer-readable medium storing code for wireless communication, the code comprising instructions executable by a processor to perform the method of one or more of Aspects 1-30.

Aspect 65: A non-transitory computer-readable medium storing a set of instructions for wireless communication, the set of instructions comprising one or more instructions that, when executed by one or more processors of a device, cause the device to perform the method of one or more of Aspects 1-30.

Aspect 66: An apparatus for wireless communication at a device, comprising a processor; memory coupled with the processor; and instructions stored in the memory and executable by the processor to cause the apparatus to perform the method of one or more of Aspects 31-60.

Aspect 67: A device for wireless communication, comprising a memory and one or more processors coupled to the memory, the one or more processors configured to perform the method of one or more of Aspects 31-60.

Aspect 68: An apparatus for wireless communication, comprising at least one means for performing the method of one or more of Aspects 31-60.

Aspect 69: A non-transitory computer-readable medium storing code for wireless communication, the code comprising instructions executable by a processor to perform the method of one or more of Aspects 31-60.

Aspect 70: A non-transitory computer-readable medium storing a set of instructions for wireless communication, the set of instructions comprising one or more instructions that, when executed by one or more processors of a device, cause the device to perform the method of one or more of Aspects 31-60.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit, to a network entity, a processing timeline indication associated with a physical downlink shared channel (PDSCH) communication, wherein the processing timeline indication indicates a minimum feedback channel offset value for processing the PDSCH communication; and
receive, from the network entity, a physical uplink control channel (PUCCH) indication that schedules a PUCCH resource for transmitting a feedback communication associated with the PDSCH communication, wherein the PUCCH indication is based at least in part on the processing timeline indication.

2. The apparatus of claim 1, wherein the minimum feedback channel offset value is associated with a transmission configuration indicator (TCI) state indicated by the processing timeline indication.

3. The apparatus of claim 1, wherein the processing timeline indication is transmitted using a layer 1 (L1) beam report.

4. The apparatus of claim 3, wherein the one or more processors are further configured to transmit, to the network entity, a candidate processing timeline indication that indicates multiple minimum feedback channel offset values for processing PDSCH communications, wherein each of the multiple minimum feedback channel offset values is associated with a corresponding decoding process.

5. The apparatus of claim 4, wherein the processing timeline indication indicates a selected minimum feedback channel offset value of the multiple minimum feedback channel offset values.

6. The apparatus of claim 5, wherein the selected minimum feedback channel offset value is associated with one or more transmission configuration indicator (TCI) states having a source reference signal associated with at least one of a channel state information (CSI) reference signal resource indicator (CRI) or a synchronization signal block (SSB) indicator indicated by the L1 beam report.

7. The apparatus of claim 1, wherein the PUCCH indication indicates a selected feedback channel offset value associated with the PUCCH resource based at least in part on the processing timeline indication, wherein the selected feedback channel offset value is one of multiple feedback channel offset values associated with a radio resource control (RRC) list.

8. The apparatus of claim 1, wherein the one or more processors are further configured to receive, from the network entity, a message reconfiguring a radio resource control (RRC) list of multiple feedback channel offset values based at least in part on the processing timeline indication, resulting in an updated RRC list of multiple feedback channel offset values.

9. The apparatus of claim 1, wherein the one or more processors are further configured to receive, from the network entity, a configuration indicating multiple radio resource control (RRC) lists of multiple feedback channel offset values, wherein each RRC list is associated with a corresponding minimum feedback channel offset value, and wherein the UE and the network entity autonomously select a first RRC list, of the multiple RRC lists, associated with the PUCCH resource based at least in part on the processing timeline indication.

10. The apparatus of claim 9, wherein the first RRC list applies after an expiration of an application timer.

11. The apparatus of claim 10, wherein the one or more processors are further configured to receive, from the network entity, an acknowledgement (ACK) message associated with the processing timeline indication, wherein the application timer begins at a time at which the UE receives the ACK message.

12. The apparatus of claim 10, wherein the application timer begins at a time at which the UE transmits the processing timeline indication.

13. The apparatus of claim 1, wherein the one or more processors are further configured to receive, from the network entity, an acknowledgement (ACK) indication associated with the processing timeline indication.

14. The apparatus of claim 13, wherein the processing timeline indication is transmitted using a medium access control (MAC) control element (MAC-CE) message, and wherein the ACK indication is indicated by the network entity scheduling a physical uplink shared channel (PUSCH) transmission with a same hybrid automatic repeat request (HARD) process identifier as a resource in which the MAC-CE message was transmitted.

15. The apparatus of claim 13, wherein the ACK indication is included in a feedback field of a downlink control information (DCI) message received from the network entity within a time window after transmitting the processing timeline indication.

16. The apparatus of claim 13, wherein the ACK indication is included in a downlink control information (DCI) message received from the network entity within a time window after transmitting the processing timeline indication, and wherein the ACK indication is indicated using a combination of information bits in one or more non-feedback fields of the DCI message.

17. The apparatus of claim 13, wherein the ACK indication is indicated by the network entity transmitting a message reconfiguring a radio resource control (RRC) list of multiple feedback channel offset values, resulting in an updated RRC list of multiple feedback channel offset values.

18. The apparatus of claim 1, wherein the one or more processors are further configured to receive, from the network entity, a negative acknowledgement (NACK) indication associated with the processing timeline indication.

19. The apparatus of claim 1, wherein the one or more processors are further configured to transmit, to the network entity, another processing timeline indication associated with another PDSCH communication, wherein the other processing timeline indication indicates another minimum feedback channel offset value for processing the other PDSCH communication, wherein the other processing timeline indication is transmitted after a prohibit timer has elapsed, and wherein the prohibit timer begins at a time at which the UE transmits the processing timeline indication.

20. The apparatus of claim 1, wherein the one or more processors are further configured to transmit, to the network entity, another processing timeline indication associated with another PDSCH communication, wherein the other processing timeline indication indicates another minimum feedback channel offset value for processing the other PDSCH communication; and
receive, from the network entity, another PUCCH indication that schedules another PUCCH resource for transmitting another feedback communication associated with the other PDSCH communication, wherein the other PUCCH indication is based at least in part on the other processing timeline indication, and wherein the other PUCCH resource occurs prior to the PUCCH resource.

21. An apparatus for wireless communication at a network entity, comprising:
a memory; and
one or more processors, coupled to the memory, configured to:
receive, from a user equipment (UE), a processing timeline indication associated with a physical downlink shared channel (PDSCH) communication, wherein the processing timeline indication indicates a minimum feedback channel offset value for processing the PDSCH communication; and
transmit, to the UE, a physical uplink control channel (PUCCH) indication that schedules a PUCCH resource for transmitting a feedback communication associated with the PDSCH communication, wherein the PUCCH indication is based at least in part on the processing timeline indication.

22. The apparatus of claim 21, wherein the minimum feedback channel offset value is associated with a transmission configuration indicator (TCI) state indicated by the processing timeline indication.

23. The apparatus of claim 21, wherein the processing timeline indication is received via a layer 1 (L1) beam report.

24. The apparatus of claim 23, wherein the one or more processors are further configured to receive, from the UE, a candidate processing timeline indication that indicates multiple minimum feedback channel offset values for processing PDSCH communications, wherein each of the multiple minimum feedback channel offset values is associated with a corresponding decoding process.

25. The apparatus of claim 21, wherein the PUCCH indication indicates a selected feedback channel offset value associated with the PUCCH resource based at least in part on the processing timeline indication, wherein the selected feedback channel offset value is one of multiple feedback channel offset values associated with a radio resource control (RRC) list.

26. A method of wireless communication performed by a user equipment (UE), comprising:
transmitting, to a network entity, a processing timeline indication associated with a physical downlink shared channel (PDSCH) communication, wherein the processing timeline indication indicates a minimum feedback channel offset value for processing the PDSCH communication; and
receiving, from the network entity, a physical uplink control channel (PUCCH) indication that schedules a PUCCH resource for transmitting a feedback communication associated with the PDSCH communication, wherein the PUCCH indication is based at least in part on the processing timeline indication.

27. The method of claim 26, wherein the processing timeline indication is transmitted using a layer 1 (L1) beam report.

28. The method of claim 26, wherein the PUCCH indication indicates a selected feedback channel offset value associated with the PUCCH resource based at least in part on the processing timeline indication, wherein the selected feedback channel offset value is one of multiple feedback channel offset values associated with a radio resource control (RRC) list.

29. A method of wireless communication performed by a network entity, comprising:
receiving, from a user equipment (UE), a processing timeline indication associated with a physical downlink shared channel (PDSCH) communication, wherein the processing timeline indication indicates a minimum feedback channel offset value for processing the PDSCH communication; and
transmitting, to the UE, a physical uplink control channel (PUCCH) indication that schedules a PUCCH resource for transmitting a feedback communication associated with the PDSCH communication, wherein the PUCCH indication is based at least in part on the processing timeline indication.

30. The method of claim 29, wherein the processing timeline indication is received via a layer 1 (L1) beam report.
